(19) United States
(12) Patent Application Publication
(10) Pub. No.: US 2021/0180450 A1
(43) Pub. Date: Jun. 17, 2021

(54) HIGHLY WEAR-RESISTANT SINGLE-PIECE CHISEL TIP BODY, MILLING CHISEL FOR A GROUND MILLING MACHINE, MILLING DRUM, AND GROUND MILLING MACHINE

(71) Applicant: BOMAG GMBH, Boppard (DE)

(72) Inventor: Steffen WACHSMANN, Boppard (DE)

(21) Appl. No.: 16/768,806

(22) PCT Filed: Nov. 27, 2018
(86) PCT No.: PCT/EP2018/000533

§ 371 Date: Jun. 1, 2020

(30) Foreign Application Priority Data
Dec. 1, 2017 (DE) 10 2017 011 131.6

(51) Int. Cl. E21C 35/183; E01C 23/088; B23B 27/14

(52) U.S. Cl. CPC E21C 35/1837; B23B 2226/315; B23B 27/145; E01C 23/088

(57) ABSTRACT

A highly wear-resistant chisel tip body comprising a material that includes diamond particles or monocrystalline diamond structures, in particular a PCD, CVD or NPD material, with a cutting top and a mounting bottom opposite said cutting top, via which the chisel tip body is attachable to a support body. The invention further relates to a milling chisel, a milling drum, as well as a ground milling machine having such a chisel tip body.

### FIELD

The invention relates to a highly wear-resistant chisel tip body, a milling chisel for a ground milling machine, a milling drum, and a ground milling machine

### BACKGROUND

Ground milling machines of the type relevant in the present context are usually employed in road or pathway construction, when creating trenches, as well as in the extraction of natural resources in surface mining In most cases, they comprise a machine frame or chassis, an operator platform and several running gears. They further include a drive engine, usually a diesel combustion engine, providing propulsion to the ground milling machine, in particular its running gears and the working device. Generic ground milling machines are known, for example, from applicant's DE 10 2013 020 679 A1 and DE 10 2013 002 639 A1.

The working device of the ground milling machine may in particular be a milling drum, which is typically mounted for rotation about its rotation axis extending, in most cases, horizontally and transversely to the working direction inside a milling drum box which is closed towards the sides and the top and is open towards the ground. The milling drum is, for example, hollow-cylindrical and has a jacket surface which is equipped with a plurality of tool devices. The tool devices typically each comprise a milling chisel and a chisel holder. The chisel holder is connected to the milling tube of the milling drum and carries the milling chisel. The chisel holder may, for example, be designed as a single piece or, alternatively, it may comprise multiple components, in particular a base holder and a quick-change tool holder which is attached to the base holder and is designed for actually receiving the milling chisel. With regard to the structure of generic tool devices, reference is made to applicant's DE 10 2010 044 649 A1 and DE 10 2010 051 048 A1. In working operation of the ground milling machine, the tool devices are driven into the underlying ground through the rotation of the milling drum, thereby milling the ground. When the ground milling machine moves in the working direction during milling operation, the underlying ground material is thus milled along a milling track. Depending on the machine type and the application, the loose milled material may subsequently be transferred, via a discharge conveyor, to a transport vehicle and may be transported away by the latter (which is typically the case with surface miners and road millers), or it may remain on the ground (which is typically the case with stabilizers and recyclers). In the case of trench millers, the milled ground material is frequently deposited alongside the trench.

During the milling process, the tool devices and in particular the milling chisels are subject to heavy wear. The milling chisels of the tool devices therefore need to be renewed at regular intervals. As for the mounting of the milling chisel, it is known, for example, to either attach the chisel rotatably in the chisel holder or to arrange it in a rotationally fixed manner in or at the chisel holder. For this, the milling chisel may be mounted inside the chisel holder, for example, via a press fit. Such a type of connection is frequently considered, for example, when the milling chisels being used include materials, in particular chisel tip bodies, having a relatively high hardness.

A typical chisel device of the present type comprises a chisel holder and a chisel, in particular a round shank chisel. The chisel holder is in this case attached, for example welded, to the jacket surface of a support tube of the milling drum, and the milling chisel is inserted into a receiving opening of the chisel holder and is held there such that, in a worn state, it can be removed and replaced with a new milling chisel by an operator as quickly and simply as possible. Besides single-piece variants, the chisel holder may also comprise multiple and in particular two subunits, for example a base holder and a quick-change tool holder. In this case, the base holder is attached to the milling drum. The quick-change tool holder is removably fixed to the base holder, and the milling chisel is in turn inserted into the quick-change tool holder. With this structure, both the milling chisel and also the quick-change tool holder can be renewed in a quick and simple manner when worn.

A milling chisel of the present type typically includes a base body, for example made of steel, which comprises a shank and a head and is ideally a massive single piece. An additional protective cap may be attached to the base body, in particular at the head. In most cases, the head of the milling chisel merges into a tip formed by a chisel tip body. This chisel tip body may consist of a different material than the base body, for example a hard metal, and may be attached to the base body, for example, by brazing, and thus makes the first contact with the ground to be milled by cutting the latter in working operation. Such a milling chisel is known, for example, from applicant's DE 10 2014 016 500 A1. Accordingly, the tip is located at least partially in front of the base body in the tool's advancing direction. In working operation of the ground milling machine, the milling chisel immerses with its tip ahead into the ground and mills it. The tool's advancing direction here designates the direction in which the milling chisel contacts the ground to be milled and is driven through the underlying ground. For simplification, it may be assumed that the tool's advancing direction usually extends at an obtuse angle to the longitudinal axis of the milling chisel and from the shank towards the tip. In working operation, the tip of the chisel is accordingly exposed to considerable shear forces and bending moments. The material milled off the ground slides past the chisel head and parts of the chisel holder. In terms of its function, the chisel may be divided into two regions. The tool region is the part of the milling chisel that protrudes from the chisel holder and comprises the head, the tip or chisel tip body, and other devices at the milling chisel. This part of the milling chisel is in direct contact with the milled material, so that this region is particularly exposed to heavy material stress and wear. In other words, the tool region designates that region of the milling chisel which protrudes from the chisel holder in working operation or when in the position inserted into the chisel holder. The second region is the shank or holder region, which essentially comprises the shank of the milling chisel and is surrounded and covered towards the outside by the chisel holder in working operation.

Further chisels are known, for example, from DE 31 12 459 A1. Said document describes a chisel that includes a support body made of steel and a chisel jacket body including a tip made of a ceramic material. The ceramic material is to reduce sparking during the milling process, which may be particularly relevant in mining in the presence of explosive dust/air mixtures or gases. For ground milling machines, chisels made of ceramics have failed to become a widespread solution due to the higher fracture susceptibility compared to hard metals. Also known, for example from DE 40 39 217 A1, are milling chisels having a hard metal tip. In addition to the tip, a wear-resistant layer is applied to the chisel head, which is to prevent breakage of the head. However, this solution likewise fails to provide a satisfactory service life of the milling chisels. WO 2014/049010 A2 discloses a chisel having a PCD-containing tool tip.

Milling chisels having chisel tips that comprise a highly wear-resistant material do not require rotation of the milling chisel inside the chisel holder. In the present context, highly wear-resistant materials are in particular materials that have a Mohs hardness of more than 7.5 and in particular more than 8. Such highly wear-resistant materials are thus in particular boron nitride, tungsten carbide or other hard metals. In the present context, hard metals are to mean in particular sintered composite materials consisting of one or more reinforcing phases (for example tungsten carbide) and a binder (for example cobalt, nickel and/or iron) and characterized by particularly high hardness, hot hardness and wear resistance. In the present context, an ultra high strength material refers to materials comprising or created of diamond particles or monocrystalline diamond structures. An ultra high strength material very particularly refers to a so-called PCD material (polycrystalline diamond, in particular with the designation “DP” according to ISO 513), an NPD material (nano-polycrystalline diamond, as described, for example in “Novel Development of High-Pressure Synthetic Diamonds Ultra-hard Nano-polycrystalline Diamonds” by Hitoshi Sumiya in Sei TECHNICAL REVIEW, vol. 74, April 2012, pages 15 to 23, which is incorporated herein by reference), or a CVD material (chemical vapor deposition, for example by Norton Diamond Films, USA). PCD, NPD and CVD materials are all characterized by the fact that they comprise synthesized diamonds. These are in particular dispersed (PCD, NPD) in random orientation in a metal matrix acting as a carrier. The chisel tips according to the invention are thus characterized in that they exhibit very little wear in working operation compared to conventional chisel tips and therefore achieve very long service lives.

A problem in the known chisels of the type mentioned above with a chisel tip body made of a material including diamond particles is that they tend to break in the region of or directly at the brazed connection between the chisel tip body and the structure supporting the latter in the chisel, which equals an immediate total failure of the chisel. This is particularly apparent when binder and base course layers with rougher and harder asphalt aggregates are to be processed. One reason for the increased tendency to break seems to be an unfavorable force deflection of the shear forces occurring at the chisel tip in the milling process, which overloads the connection between the chisel tip body and the chisel base body, which ultimately results in a breakage of the chisel tip body.

### SUMMARY

Based on the highly wear-resistant chisel tip bodies known from the prior art, the object of the invention is thus to provide a solution for improving the service life and the range of applications of such milling chisels with a chisel tip body made of a highly wear-resistant material.

The object is achieved with a highly wear-resistant chisel tip body, a chisel for a ground milling machine, a milling drum, and a ground milling machine according to the independent claims. Preferred embodiments are cited in the dependent claims.

In the present context, an ultra high strength material is to mean highly wear-resistant materials that include materials comprising or created of diamond particles or materials having at least partially monocrystalline diamond structures. An ultra high strength material very particularly refers to a so-called PCD material (polycrystalline diamond, in particular with the designation “DP” according to ISO 513), an NPD material (nano-polycrystalline diamond, as described, for example in “Novel Development of High-Pressure Synthetic Diamonds Ultra-hard Nano-polycrystalline Diamonds” by Hitoshi Sumiya in Sei TECHNICAL REVIEW, vol. 74, April 2012, pages 15 to 23, which is incorporated herein by reference), or a CVD material (chemical vapor deposition, for example by Norton Diamond Films, USA). In particular with respect to PCD and NPD materials, these ultra high strength materials have a transverse rupture strength of >1.5 GPa and a hardness of more than 35 GPa. These quantities may be determined, for example, by clamping and loading a specimen in 4 mm SiC pressing jaws at room temperature, as described in “Novel Development of High-Pressure Synthetic Diamonds Ultra-hard Nano-polycrystalline Diamonds” by Hitoshi Sumiya in Sei TECHNICAL REVIEW, vol. 74, April 2012, pages 15 to 23. So-called PCD materials (polycrystalline diamond) or NPD materials (nano-polycrystalline diamond) or CVD materials are particularly suitable for use in the present context. The PCD materials are synthesized diamond particles that are dispersed and/or intergrown in random orientation in a metal matrix. For this, a two-phase manufacturing process is usually resorted to, wherein the HPHT technique (high-pressure high-temperature synthesis) has proven to be particularly suitable to obtain the diamond particles. This produces diamonds having grain sizes of essentially between 2 μm to 400 μm, preferably between 2 μm to 400 μm. This is followed, for example, by high-pressure liquid-phase sintering, in which the diamond layer is applied to a hard metal base body which in particular contains cobalt and, by adding metallic solvent catalysts and other sintering assistants, is combined to obtain a polycrystalline matrix. Thus, this frequently produces a kind of layered composite material of a polycrystalline diamond matrix on a hard metal base body separated by a cobalt-enriched boundary layer. The manufacturing of PCD materials is per se known in the prior art. NPD materials differ from the PCD materials, on the one hand, essentially in the size of the particles obtained in the synthesis process of the diamonds, which for NPD materials is approximately in the two-digit nanometer range. Under certain conditions (15 GPa, high temperature in the range from 2,200 to 2,300° C., addition of high-purity graphite), single-phase nano-polycrystalline diamond can be obtained that has excellent hardness and bending stiffness properties. For the manufacturing and the properties of the obtained NPD material, which is inter alia relevant for the present invention, reference is made in particular also to the article “Novel Development of High-Pressure Synthetic Diamonds ‘Ultra-hard Nano-polycrystalline Diamonds’” by Hitoshi Sumiya in SEI Technical Review, vol. 74, April 2012, pages 15 to 23.

A first aspect of the invention relates to a highly wear-resistant chisel tip body comprising a material that comprises or is created of diamond particles or comprises a monocrystalline diamond structure. Such a material very particularly refers to a so-called PCD material (polycrystalline diamond, in particular with the designation “DP” according to ISO 513), an NPD material (nano-polycrystalline diamond, as described, for example in “Novel Development of High-Pressure Synthetic Diamonds Ultra-hard Nano-polycrystalline Diamonds” by Hitoshi Sumiya in Sei TECHNICAL REVIEW, vol. 74, April 2012, pages 15 to 23, which is incorporated herein by reference), or a CVD material (chemical vapor deposition, for example by Norton Diamond Films, USA). The highly wear-resistant chisel tip body includes a cutting top and a mounting bottom opposite the cutting top, via which the chisel tip body is attachable to a support body of the milling chisel. The cutting top designates that external side of the chisel tip body which is intended for the contact with the ground material in milling operation. The mounting bottom or attachment side, on the other hand, designates that side of the chisel tip body that is for attachment to a support structure, in particular a part of the milling chisel. The chisel tip body designates that part of a milling chisel that forms its cutting tip and, in the present context, comprises an ultra high strength material. The milling chisel according to the invention can normally be obtained by attaching the separately fabricated chisel tip body to the remaining milling chisel, in particular to its head region and more particularly to a holding cap, for example by brazing or soldering. The cutting top is usually located opposite the mounting bottom. Besides the material selection according to the invention, the chisel tip body according to the invention is further characterized by its spatial design. That is, provision is further made according to the invention for the cutting top to include a cutting tip and two cutting flanks declining from the cutting tip and arranged opposite each other, in particular in a roof-like manner. The cutting tip thus designates a point of the surface of the cutting top of the chisel tip body that projects in a direction away from the mounting bottom to a maximum extent compared to the further environment. Starting from this cutting tip, two laterally declining cutting flanks are provided, in particular in the form of planar surface segments. In this manner, a shape of the chisel tip body that widens against the cutting direction of the chisel tip body is obtained, which ultimately achieves the cutting effect. According to the invention, the chisel tip base body is further designed such that, when projected into a plane, the cutting top has a circumferential outer contour and the cutting tip is arranged, with respect to said outer contour, at an off-center position within said outer contour. The outer contour thus corresponds to the circumferential edge of the cutting top of a projection into a virtual reference plane, in particular into a plane that is orthogonal to a symmetry plane of the chisel tip body, as will be explained in more detail below. This corresponds in particular to the top view of the cutting top of the chisel tip body, i.e. the view against the cutting direction onto the chisel tip body. This two-dimensional circumferential outer contour has a center point. An essential aspect now is the fact that the cutting tip is not arranged at said center point, as is commonly the case, for example, for circular chisel tip bodies, but is instead offset relative to said center point towards the outer contour. This gives the chisel tip body an oblique overall structure, which enables a particularly advantageous fixation of the chisel tip body to a support body, as will be explained in more detail below. Provision is further made for the chisel tip body according to the invention to include a ridge line extending, starting from the chisel tip, towards the opposite side, in particular at least partially towards the center of the outer contour and along at least one cutting flank, and declining towards the mounting bottom, such that the chisel tip, the ridge line and the two cutting flanks form a cutting wedge, in particular in the form of a base body resembling an oblique pyramid. The ridge line designates a boundary line which starts from the chisel tip and is defined by the points of the chisel tip body spaced by a maximum perpendicular distance from the aforementioned reference plane. The ridge line is in particular linear, but may generally also be at least partially curved. The ridge line of the chisel tip body is thus that contour line of the chisel tip body which is defined by the cutting top in a projection of the chisel tip body into a virtual reference plane transverse to the virtual reference plane for determining the aforesaid outer contour, or in a side view of the chisel tip body onto the side of one of the cutting flanks. Said ridge line is thus located on the cutting top between the two cutting flanks. The combination of the material selection according to the invention and the specific shaping according to the invention ultimately results in a chisel tip body that enables, on the one hand, a very long service life and, on the other hand, an optimized force deflection of shear forces, as will be explained in more detail below.

In addition, the chisel tip body preferably includes two opposed cutting flank surfaces extending at an angle ranging from 60° to 150°, in particular 110° to 90°. The cutting flank surfaces are essentially planar surfaces that extend from the respective chisel tip and the ridge line towards the attachment side of the chisel tip body. This improves the cutting effect of the chisel tip body and the material deflection in the region of the chisel tip body.

The ultra high strength material preferably has a hardness of more than 40 GPa and a bending rupture strength of more than 2 GPa. For this, use is particularly preferably made of a PCD and/or NPD material.

The chisel tip body may generally be made of a uniform material. It has, however, proven to be advantageous if, for manufacturing the chisel tip body, the latter is preferably obtained by sintering a tip body of a polycrystalline diamond matrix with a base body consisting of a hard metal such as in particular tungsten carbide. During manufacturing, the chisel tip body, which will subsequently be attached to the support body of the chisel, thus comprises two separate parts that are sintered together. The chisel tip body can then be obtained by placing a preform including a chisel tip on a bottom piece. Said bottom piece does preferably not comprise any PCD or NPD or CVD material and consists, for example, of tungsten carbide and cobalt. In the further manufacturing process, this facilitates inter alia the subsequent attachment of the chisel tip body to the support body, in particular by brazing. Moreover, the amount of the diamond material used can then be reduced, which is advantageous in particular for cost reasons.

The ridge line may be a cutting edge having a line-shaped progression. Preferably, however, the ridge line is a part of an essentially planar ridge surface and is thus an actual line essentially only in the side view described above. The advantage of a ridge line is in particular the increased resistibility. The planar ridge surface ideally has a triangular contour, which is more particularly shaped so as to widen in a direction away from the chisel tip.

According to the manufacturing process, provision may further be made for the cutting tip to be rounded or shaped as a rounded cone cap. Additionally or alternatively, the transitions from the cutting tip to the cutting flanks and/or the ridge line or the ridge line and/or further contour lines may include rounded transition regions.

The chisel tip body preferably comprises a subregion shaped as an oblique pyramid. According to the invention, the chisel tip body is additionally or alternatively surface-symmetrical and not rotation-axially symmetrical. Moreover, the outer contour of the chisel tip body is additionally or alternatively preferably axially symmetrical and/or centrosymmetrical and not rotationally symmetrical. Additionally or alternatively, the outer contour of the chisel tip body in the top view described above further preferably corresponds to a planar shape with at least four or more corners, in particular a hexagon.

According to the invention, it is generally possible that the chisel tip body comprises only one single cutting tip. However, in the further manufacturing process, the chisel tip body is then required to be positioned on the support body of a milling chisel at one single, specifically defined position. To facilitate manufacturing, it has proven to be advantageous if the chisel tip body according to the invention comprises multiple and particularly preferably exactly two chisel tips spaced from one another by a saddle region, said saddle region being recessed from the two chisel tips towards the mounting bottom. Through the concurrent integration of at least two cutting tips into one and the same chisel tip body, it is possible to not only improve cutting properties and achieve an optimized force distribution in the cutting process but to also facilitate manufacturing of a milling chisel having a chisel tip body according to the invention. The saddle region designates the region between the two chisel tips and usually comprises the ridge line, which extends through the saddle region between the two chisel tips. The ridge line of the saddle region is the shortest connection route on the external surface of the chisel tip body on the cutting top. It further includes a lowest point, here referred to as saddle point, in which the perpendicular distance of the ridge line from a direct virtual connection line between the two chisel tips is the largest or at least runs through a local maximum. This saddle point thus defines a minimum of the height of the ridge line relative to the opposite attachment side of the chisel tip body. By definition, the chisel tips are further regions which project relative to the saddle point, usually with a punctiform maximum elevation. The chisel tips thus project relative to the remaining chisel tip body in a working direction and constitute that part of the chisel tip body via which the chisel tip body first makes contact with the ground to be milled in the working process. In the saddle region, on the other hand, the chisel tip body is designed with an indentation, resulting altogether in a kind of “double-wedge structure”.

The geometrical design of the chisel tip body according to the invention is of particular importance. In addition to the two chisel tips connected via the saddle region, it has proven to be advantageous if the chisel tip body is designed such that it is axially symmetrical with respect to a symmetry axis running through a lowest point, in particular the saddle point, of the saddle region. In contrast to the conventional chisel tip bodies known from the prior art, however, the chisel tip body is ideally not rotationally symmetrical. Additionally or alternatively, the chisel tip body may further be designed such that it includes a symmetry plane that extends through both cutting tips, in particular perpendicular to a direct virtual straight connection line between the two chisel tips, and/or includes a symmetry plane that extends transversely to a virtual straight connection line between the two cutting tips, in particular such that the straight connection line runs perpendicularly through the symmetry plane. The saddle point of the ridge line between the two chisel tips then preferably lies in the respective symmetry plane for both symmetry planes.

The saddle region preferably comprises two essentially linear ridge lines extending within an angular range from <180° to 150°, in particular from 175° to 165°, relative to one another. The ridge line extending between the two chisel tips is thus ideally composed of two straight ridge lines that lie at an obtuse angle to one another and define the indentation in the chisel tip body between the two chisel tips.

It is generally possible that each of the at least two chisel tips has two associated planar cutting flanks, wherein the two cutting flanks may also extend at an angle to one another on one side of the chisel tip body. It is, however, preferred if the chisel tip body includes a respective planar cutting flank on the one side and on the other side, which ends in both chisel tips.

It has proven to be preferable if the chisel tip body has a longitudinal extension or is elongated with respect to its base or contact area. Its length to width ratio then is ideally larger than 1.2, in particular larger than 1.4, and more particularly larger than 1.5. These size data refer to the projection of the extension of the chisel tip body into a virtual reference plane from an orthogonal top view to the cutting side of the chisel tip body.

The chisel tip base body is further preferably designed such that it includes two opposed longitudinal edges extending in particular within an angular range of +/−10°, and in particular parallel to one another. Additionally or alternatively, it may further comprise a circumferential side wall extending in particular orthogonally to the mounting side.

The respective outer lateral boundary walls of the chisel tip body preferably include two opposed and in particular linear longitudinal edges, which in particular extend within an angular range of +/−10°, and in particular parallel to one another.

It is generally possible to design the two chisel tips as pointed cones. However, in order to achieve an initial structure that is particularly resistant to mechanical stress right from the beginning, it is preferred if the chisel tips and/or the transition in the saddle region of the chisel tip body is rounded, in particular with a rounding radius ranging from 1 mm to 3 mm.

A further aspect of the invention consists in a chisel for a ground milling machine having a chisel tip body according to the invention, as described above. The milling chisel comprises an elongated chisel shank that is in particular rotationally symmetrical about its longitudinal axis. The milling chisel is mounted in a suitable milling chisel holder via the chisel shank, as is generally known per se from the prior art. The chisel shank thus constitutes the essential mounting structure of the milling chisel and is, for example, not intended for making direct contact with the milled material, at least not with appreciable portions. The chisel shank is normally received by a shank recess in the milling chisel holder and may further comprise parts of a chisel attachment device such as contact surfaces, screw threads, grooves, etc.

The chisel shank preferably consists of a material that is not highly wear-resistant, in particular a steel that is not highly wear-resistant. The chisel shank of the milling chisel according to the invention is further preferably designed to be rotationally symmetrical, in particular about its longitudinal axis. The chisel shank ideally includes a conical portion that narrows or tapers in a direction away from the chisel tip. In this region, the radius of the chisel shank thus becomes continuously smaller. With the aid of such a conical portion, a reliable press fit can later be obtained when mounting the milling chisel in a holder in order to mount the milling chisel in a rotationally fixed manner Additionally or alternatively, the chisel shank is preferably designed such that it includes a cylindrical portion which in particular directly adjoins the conical portion. In this portion, the radius of the chisel shank is constant, in particular with respect to its longitudinal axis. This region is preferably at an end position and may be used, for example, to recess a thread or the like. The chisel shank is particularly preferably designed such that, in a direction away from the head region of the chisel along the longitudinal axis of the milling chisel, a conical portion is adjoined by a cylindrical portion, in particular at an end position.

In order to enable secure attachment of the milling chisel in a milling chisel holder, the chisel shank preferably includes at its one end (the end opposite the head region) a part of an attachment device, in particular a tensioning device, more particularly a female or male thread. This may thus be engaged by a complementary element of a threaded connection, for example a fastening screw or a fastening nut. Via this threaded connection, it is thus possible to apply a tensile force to the milling chisel which pulls the milling chisel into the chisel holder and clamps it inside the latter.

For milling chisels having a highly wear-resistant chisel tip body according to the invention, it is preferred if they are mounted in a suitable milling chisel holder in a rotationally fixed manner, so that in particular a rotating movement of the milling chisel about its longitudinal axis is prevented in milling operation. This may be done, for example, solely by applying a sufficient clamping force that enables frictional, rotationally fixed mounting of the milling chisel. The milling chisel then includes a suitable contact surface in the shank region. According to the invention, provision may however also be made for the milling chisel to include a part of a rotational locking device. This may be, for example, a form closure element, for example a protrusion in the radial direction, which enables a form closure with a suitable complementary element at a milling chisel holder in the circumferential direction relative to the rotation axis.

To provide an essentially unambiguous alignment of the milling chisel in a chisel holder, an alignment mark may further be present on the milling chisel, for example in the form of a protrusion. It is further possible that said protrusion is a part of a form closure alignment device with a complementary part at the chisel holder. This form closure device may in particular define more than two and less than five, in particular exactly three, rotational positions of the milling chisel about its longitudinal axis in order to allow more than two defined alignment positions of the milling chisel relative to the chisel holder. Additionally or alternatively, a mounting tool may be provided for attaching and/or inserting the milling chisel to/in the chisel holder, which mounting tool is designed such that the milling chisel is inserted into the chisel holder in one or more predefined rotational positions.

It is advantageous if the chisel includes a support cap, in particular an essentially conical one, having an external surface to which the chisel tip body is attached, in particular by brazing. The support cap thus designates a separate component which is connected to a shank body of the milling chisel. The support cap functions, on the one hand, to protect the shank body of the chisel and, on the other hand, to mount the chisel tip body. For the specific exemplary design of the support cap, reference is made inter alia to applicant's DE 10 2014 014 094 A1. The wear protection cap of the milling chisel preferably consists exclusively of hard metal. In the present context, hard metals are to mean sintered composite materials consisting of one or more reinforcing phases (for example tungsten carbide) and a binder (for example cobalt, nickel and/or iron) and characterized by particularly high hardness, hot hardness and wear resistance. The formulation “exclusively” in this context means that the wear protection cap itself consists exclusively, in particular in a material-uniform manner, of hard metal. This obviously also comprises embodiments in which a further layer, in particular an attachment layer such as a solder, welding and/or adhesive layer, is provided between the wear protection cap and the base body of the milling chisel.

In contrast to most chisel tip bodies known from the prior art, it is preferred according to the invention that the chisel tip body is not arranged centrally and rotationally symmetrically with respect to the longitudinal axis of the milling chisel. It is therefore also preferred that the chisel tip body is essentially arranged resting on a circular cone's external surface, in particular such that the longitudinal axis of the chisel shank and the ridge line of the chisel tip body intersect in a virtual plane spanned by these two lines, in particular at an angle ranging from 30° to 60°, in particular ranging from 40° to 50°. The circular cone's surface may be formed by a chisel base body, for example also comprising the chisel shank, or by a support cap, in particular as explained above. The circular cone's surface may be bent along its cone axis or, preferably, may be linear. Such a circular cone's surface arranged subsequent to the chisel base body in the milling direction enables good material deflection.

A further aspect of the invention consists in a milling drum, wherein, according to the invention, at least one of the cutting tools of the milling drum includes a chisel tip body according to the invention, in particular as a part of a milling chisel according to the invention. The milling drum comprises in particular an essentially hollow-cylindrical support tube having an external jacket surface on which a plurality of milling chisels is arranged, in particular via suitable chisel holders. In an optimum configuration, at least 90% of the provided milling chisels are equipped with a chisel tip body according to the invention. The milling drum is ideally completely equipped with milling chisels according to the invention, in particular with the exception of chisels protruding, in the direction of the rotation axis, beyond the milling tube at end faces thereof.

The chisel tip bodies are arranged on the milling drum by orienting the milling chisels particularly preferably such that the chisel tip body has a clearance angle of >1°, in particular up to a maximum of 15°, more particularly up to a maximum of 10°. The clearance angle designates the angle between the outer edge of the chisel tip body facing the processed ground surface and the ground surface processed during processing traversal (i.e., the corresponding tangent starting from the tip region).

In an ideal configuration, the angle of an essentially planar attachment surface, in particular a soldering surface, via which the chisel tip body is attached to a chisel tip support body, for example a support cap or a chisel base body as described above, to the tangential force transmission into the ground to be cut in working operation is in the range from 70° to 110°, in particular 80° to 100°. The force transfer from the chisel tip body to the remaining milling chisel thus occurs in an almost orthogonal angle, to that the amount of shear loads acting on the chisel tip body is relatively small.

A further aspect of the invention finally consists in a ground milling machine, in particular a road cold milling machine, a stabilizer, a recycler, a trench miller or a surface miner, having at least one chisel tip body according to the invention, in particular as a part of a milling drum according to the invention.

### BRIEF DESCRPTION OF THE DRAWINGS

The invention will be explained in more detail below by reference to the embodiment examples indicated in the figures. In the schematic figures:

FIG. 1: is a side view of a generic ground milling machine;

FIG. 2: is a side view of a chisel holder system known from the prior art;

FIG. 3: is a side view of a milling chisel known from the prior art;

FIG. 4: is a side view of the longitudinal side of a chisel tip body;

FIG. 5: is a side view of the transverse side of the chisel tip body of FIG. 4;

FIG. 6: is a top view of the chisel tip body of FIGS. 4 and 5;

FIG. 7: is an oblique perspective view of a milling chisel having a chisel tip body according to FIGS. 4 to 6;

FIG. 8: is a side view of the milling chisel of FIG. 7;

FIG. 9: is another side view of the milling chisel of FIGS. 7 and 8;

FIG. 10: is a cross-sectional view through a chisel holder having a milling chisel with a chisel tip body in an alternative design;

FIG. 11: is an oblique perspective view of the chisel of FIG. 10;

FIG. 12: is a side view of the longitudinal side of the chisel tip body of FIGS. 10 and 11;

FIG. 13: is a side view of the transverse side of the chisel tip body of FIGS. 10 to 12;

FIG. 14: is a top view of the chisel tip body of FIGS. 10 to 13;

FIG. 15: is an oblique perspective view of a preform and a bottom piece for obtaining the chisel tip body of FIGS. 10 to 14;

FIG. 16: is a perspective view of an enlarged subregion of the ground engagement of the chisel tip body of FIGS. 10 to 14;

FIG. 17: shows three alternative rotational positions of a chisel having the chisel tip body of FIGS. 10 to 14;

FIG. 18: is an oblique perspective view of a milling drum equipped with chisels having the chisel tip bodies of FIGS. 10 to 14;

FIG. 19: is an oblique perspective view of the respective top parts of a prior art milling chisel, a milling chisel according to the first embodiment example and a milling chisel according to the second embodiment example in the cutting direction;

FIG. 20: is an oblique perspective view of the respective top parts of a prior art milling chisel, a milling chisel according to the first embodiment example and a milling chisel according to the second embodiment example against the cutting direction;

FIG. 21: is an oblique perspective view of the respective top parts of a prior art milling chisel, a milling chisel according to the first embodiment example and a milling chisel according to the second embodiment example transversely to the cutting direction; and

FIGS. 22a to 22b: are side views of various ground milling machines.

### DETAILED DESCRIPTION

Like parts or functionally like parts are designated by like reference numerals in the figures. Recurring parts are not designated separately in each figure.

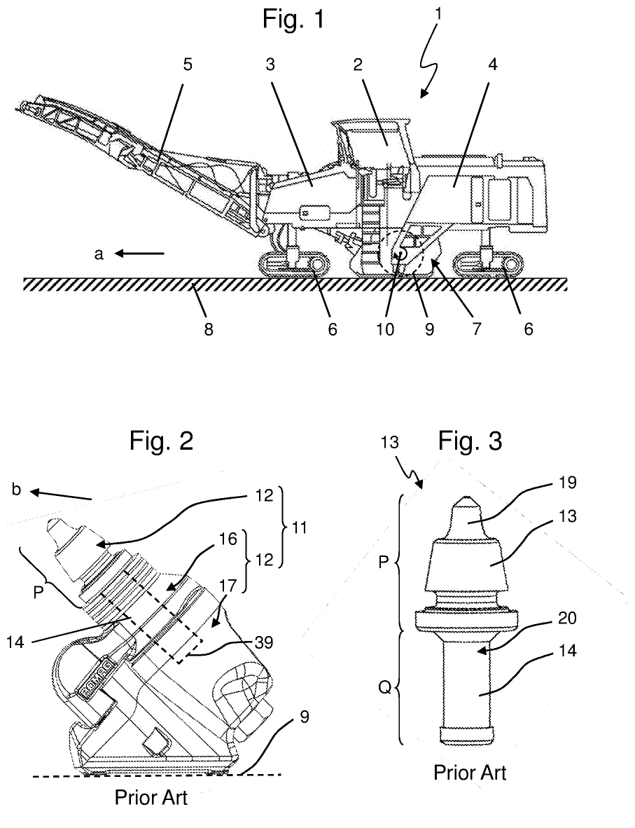

FIG. 1 illustrates a generic ground milling machine 1, in this case a road milling machine or cold milling machine of the center rotor type, in which the chisels having the chisel tip bodies according to the invention as described in more detail below can be used. It includes an operator platform 2, a machine frame 3, a drive engine 4 and traveling devices 6 (wheels or crawler tracks). In working operation of the ground milling machine 1, the ground 8 to be milled off is removed in the working direction a by a milling drum 9 mounted for rotation about the rotation axis 10 inside the milling drum box 7. The milled material is transported away via the discharge conveyor 5.

The hollow-cylindrical support tube of the milling drum 9 has a plurality of chisel devices 11 mounted thereon, one of which is indicated in FIG. 2 as an example. The chisel devices 11 each comprise a chisel holder 12 and a milling chisel 13 (=chisel), which is inserted with its shank 14 (FIG. 3; indicated by dashed lines in FIG. 2) into a receiving opening. The tool region P of the chisel 13 protrudes from the chisel holder 12. In working operation of the ground milling machine 1, said chisel region is driven into the ground in the tool's advancing direction b (also in FIG. 9) through rotation of the milling drum 9 about its rotation axis to mill off the ground. In this example, the chisel holder 12 is composed of a quick-change tool holder 16 and a base holder 17, said quick-change tool holder 16 being attached to the base holder 17 and the latter being attached to the milling drum 9.

A milling chisel 13 as known from the prior art is indicated in more detail in FIG. 3. The milling chisel 13 is subdivided into the tool region P, which contacts the underlying ground in working operation, and a holder region Q, which is located behind the former and is received in the quick-change tool holder. In the mounted state, the holder region Q is thus exclusively fitted into the receiving opening in the holder or quick-change tool holder and is thus covered towards the outside by the chisel holder 12. The milling chisel 13 further includes a chisel tip body 19 soldered onto a base body 20 of the milling chisel 13. Said chisel tip body 19 consists of an ultra high strength material and comprises diamond particles and/or a monocrystalline diamond structure, in particular a PCD or NPD material. This chisel type frequently suffers breakage of the chisel tip body in certain operation situations.

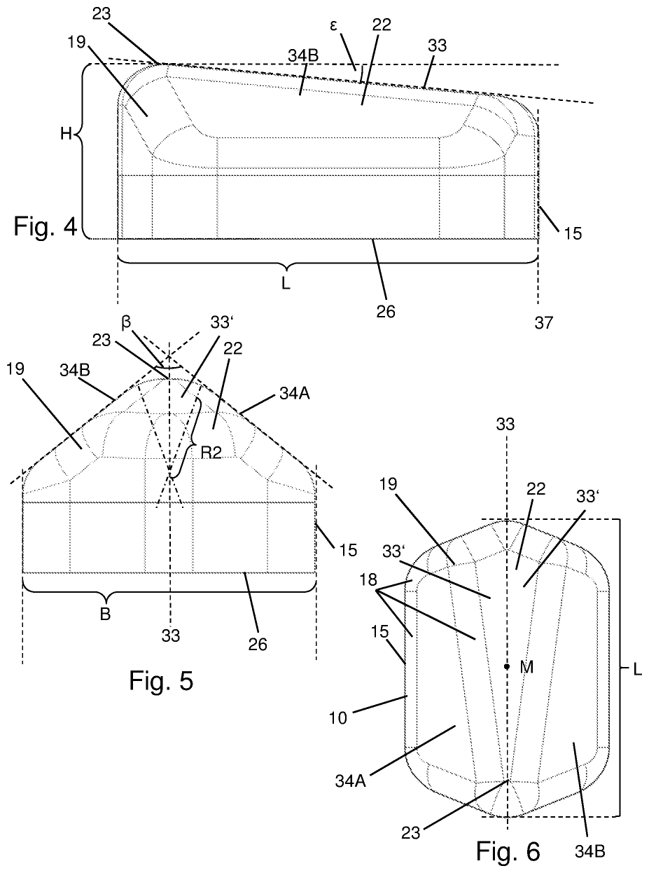

FIGS. 4 to 6 now first illustrate the structure of a highly wear-resistant chisel tip body 19 according to the invention having a cutting top or working side 22 and an attachment side or mounting bottom 26. The cutting top is that external surface of the chisel tip body 19 which in working operation makes contact with the ground material to be milled, i.e. performs the actual cutting work. This is also where the wear occurs. The mounting bottom 26, which is essentially located opposite the cutting top, on the other hand, is that side of the chisel tip body 19 via which the chisel tip body 19 is connected or linked to a support structure, in particular directly or indirectly to a chisel base body, and thus the forces applied to the chisel tip body 19 during the cutting process are deflected into the support structure.

The single-piece chisel tip base body 19 has a length L, a width B and a height H, the length L corresponding to the longitudinal extension of the chisel tip body 19 in the plane of the mounting bottom 26, the width B corresponding to the width extension extending transversely to the former in the plane of the mounting bottom 26, and the height H corresponding to the extension orthogonal to that plane. FIGS. 4 to 6 illustrate that the longitudinal extension L is larger than the width extension B and the height extension H.

On the cutting top 22, the chisel tip body 19 has a cutting tip 23. Said cutting tip thus constitutes the point or region of the cutting top 22 having a maximum distance perpendicular to the projection of the mounting bottom 26 into a virtual reference plane, i.e. in the direction of the height H. Two cutting flanks 34A and 34B, which extend opposite each other in a roof-like, mirror-symmetrical manner at the angle β, decline from the cutting tip 23. Starting from the chisel tip 23, they essentially extend towards the mounting bottom in the height direction H and to the transverse side (FIG. 5) opposite the chisel tip in the longitudinal direction L. The cutting flanks 34A and 34B are designed as planar surfaces having an essentially trapezoidal outer edge towards a ridge line or ridge surface described in more detail below and, in the downward direction, towards a circumferential side wall 15 of the chisel tip body 19. The side wall 15 has a linear progression in the height direction H and extends orthogonally to the longitudinal and width directions L and R, respectively, although shapes having a downward slope, in particular in the outward direction, curved shapes, and/or mixed shapes are also conceivable. The two cutting flanks 34A and 34B lie at the angle β relative to one another, which is preferably larger than 90° and in the present embodiment example is approximately 105°.

FIG. 6 (top view of the cutting top 22 of the chisel tip body 19) illustrates that, in the projection of the top view into a plane, the chisel tip comprises an outer contour 10 or circumferential edge which in the present embodiment example is essentially shaped as a hexagon. The chisel tip 19 is now arranged at an off-center position relative to the geometrical surface center point M (FIG. 6) of the outer contour 10, specifically offset in the longitudinal direction L towards the one side (in FIG. 6 the lower side), and is in particular located in the region of the first 25%, in particular the first 15%, of the maximum longitudinal extension in the longitudinal direction L with respect to an edge region (in FIG. 6, as an example, the lower edge region of the outer contour 10).

Starting from the chisel tip 23, a ridge line 33 further extends to the opposite transverse side of the chisel tip body 19, declining towards the mounting side 26. The ridge line 33 here corresponds to the contour line opposite the mounting side 26 in a projection of the chisel tip body 19 into a virtual reference plane spanned by the height H and the longitudinal extension L. In the embodiment example, the ridge line 33 extends, in a straight line and with a uniform slope, from the chisel tip 23 across nearly the entire longitudinal extension L towards the opposite side. Relative to a horizontal line starting from the chisel tip 23, the ridge line 33 thus extends in a line which is inclined by an angle ε of approx. 8°.

The ridge line 33 further extends within a planar ridge surface 33′, which altogether has an essentially tetragonal base area, as can be seen, for example, from FIG. 6. The ridge surface 33′ with the ridge line and the cutting flanks together form a cutting wedge that starts from the chisel tip and altogether enables excellent cutting properties and at the same time an optimized force transmission, as will be described in more detail below.

FIGS. 4, 5 and 6 further illustrate that the chisel tip body 19 in the present embodiment example is not rotationally symmetrical but is mirror-symmetrical along the ridge line 33 extending centrally through the ridge surface 33′, as can be seen in particular from FIG. 5.

In the present embodiment example, the transitions of the ridge surface 33′, the cutting flanks 34A and 34B as well as the side wall 15 are further connected to one another via rounded transition regions 18 (in the figures, the lines indicated in the surface show respective changes in the surface progression). A sharp-edged transition may be provided as well. However, the rounding is easy to manufacture and would occur with increasing wear in a more or less defined manner anyway.

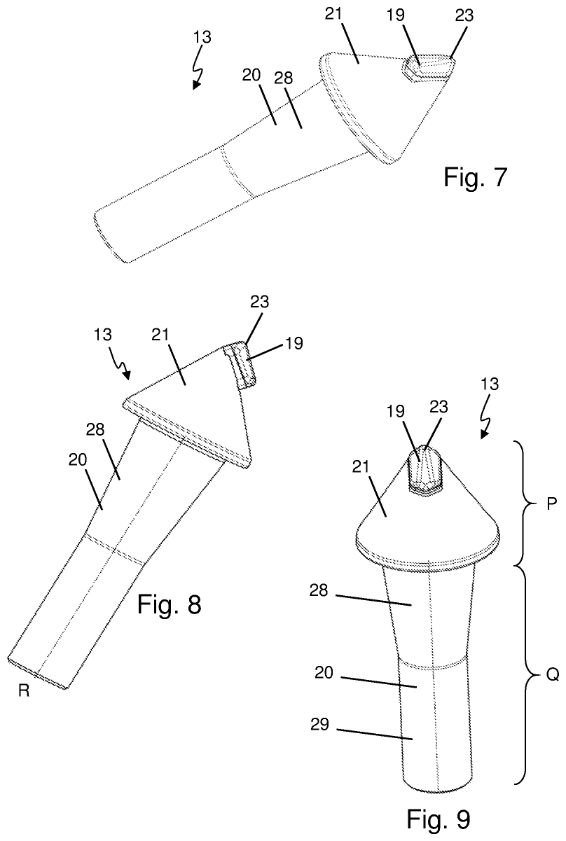

FIGS. 7, 8 and 9 now show a milling chisel 13 according to the invention in which the chisel tip body 19 described in FIGS. 4 to 6 forms the part that mills the ground in milling operation. FIG. 7 is an oblique perspective view, FIG. 8 is a side view, and FIG. 9 is a side view which is rotated by 90° about the longitudinal axis R compared to FIG. 8 and is slightly inclined towards the viewer with the chisel tip body. Essential elements of the milling chisel 13 besides the chisel tip body are a base body 20 designed rotationally symmetrical about its longitudinal axis with a holder region Q essentially formed by a chisel shank body 27 and a tool region P which in the present embodiment example is formed towards the outer side by a holding cap 21 essentially covering the tip region of the milling chisel 13. The chisel shank body 27 essentially comprises a steel support body which forms the conical portion 28 and the cylindrical portion 29 in the holder region Q adjoining the holding cap 21, in particular in an integral and material-uniform manner The cylindrical portion 29 may, for example, additionally include a male or female thread for the purpose of attachment inside a chisel holder, in particular at an end position. The holding cap 21 preferably likewise consists of a hard metal or at least of a material that has a higher resistibility against wear compared to conventional steel.

The chisel tip body 19 is laterally attached to the essentially circular-conical holding cap 21, in particular via a suitable soldered connection, in particular a brazed connection. Starting from the point of maximum projection formed by the cutting tip 23, the chisel tip body thus extends in the direction of the longitudinal axis of the chisel shank towards the holder region Q, and thus in the present case laterally along the external jacket surface of the holding cap 21. For this, provision may in particular be made for a specifically dedicated flattening and/or groove with a planar contact surface at the holding cap 21 for fixing the chisel tip body 19 with its mounting bottom 26 to the external side of the holder cap 21, in particular via a brazed connection. What is essential here is that the tip, i.e. the point of maximum projection in the direction of the rotation axis or longitudinal axis R of the milling chisel 13, is formed by the cutting tip 23 of the chisel tip base body 19 and not by the holder cap 21. This ensures that the actual cutting work is primarily performed by the chisel tip body 19 of the milling chisel 13.

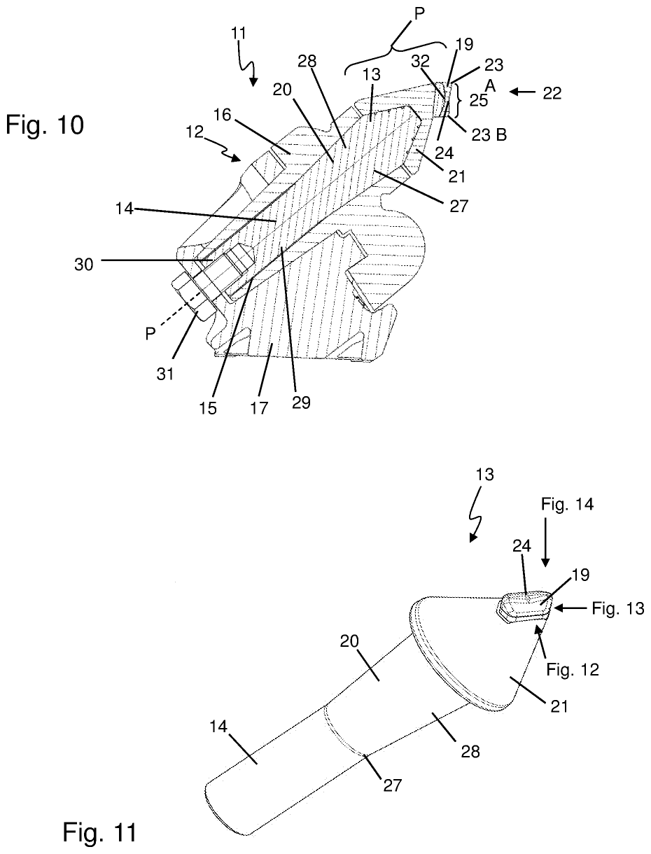

FIGS. 10 to 16 show a second embodiment example of the invention. FIG. 10, to begin with, is a cross-sectional view through a base holder 17, which may, for example, be welded onto the external jacket surface of a milling drum tube and has an inserted quick-change chisel holder 16 which in turn holds the milling chisel 13. A holding part, via which the chisel shank body 27 is connected to the holding cap 21, is first adjoined by a conical portion 28 tapering, in a direction away from the holding cap 21, perpendicular to the axis P, which finally merges into an attachment portion 29. The latter comprises a female thread 30 for receiving a fastening screw 31 for clamping the milling chisel 13 inside the chisel holder 12 in a manner known per se in the prior art. The difference between the milling chisel 13 shown here and the first embodiment example consists in the specific geometrical design of the chisel tip body 19, as will be explained in more detail below.

In contrast to the first embodiment example, the chisel tip body 19 comprises, on its working side or cutting top 22, two cutting tips 23a and 23b spaced from one another, which are spaced from one another by the distance 25 via a saddle region 24. In this case as well, the single-piece chisel tip body 19 comprises an ultra high strength material, preferably a PCD or NPD material. Again, an attachment side 26 is provided opposite the cutting top 22, via which the chisel tip body 19 is attached to an essentially circular-conical holding cap 21, in particular via a soldered connection. On the side opposite the chisel tip body 19, the circumferential, material-uniform and integral holding cap 21 is connected to a chisel shank body 27, which in actual working operation essentially functions to carry the milling chisel 13 in a chisel holder 12. It may consist, for example, of a steel material.

Further details regarding the design of the chisel shank body 27, which is essentially rotationally symmetrical about the axis P, can also be taken in particular from FIG. 11, which shows the milling chisel 13 of FIG. 10 in an oblique perspective view. A holding part, via which the chisel shank body 27 is connected to the holding cap 21, is first adjoined by a conical portion 28 tapering, in a direction away from the holding cap 21, perpendicular to the axis P, which finally merges into an attachment portion 29. The latter comprises a female thread 30 for receiving a fastening screw 31 for clamping the milling chisel 13 inside the chisel holder 12 in a manner known per se in the prior art. The difference between the milling chisel 13 shown here and the first embodiment example consists in the specific geometrical design of the chisel tip body 19, as will be explained in more detail below. As regards further features of the second embodiment example, reference is further made to the corresponding discussions of the first embodiment example, and vice versa.

FIGS. 10 and 11 thus illustrate that also the chisel tip body 19 of this embodiment example is, in contrast to the prior art, not set atop the tip of the holding cap 21 but is instead essentially attached laterally in the tip region of the holding cap 21 (wherein recesses may in particular be provided in the holding cap 21 to enable planar attachment of the chisel tip body 19 via the soldered connection) while at the same time forming the tip of the milling chisel 13.

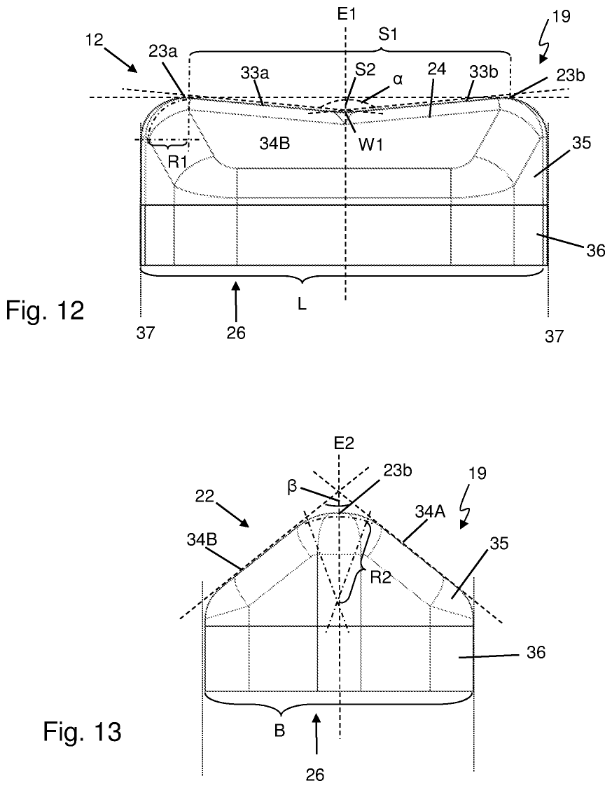

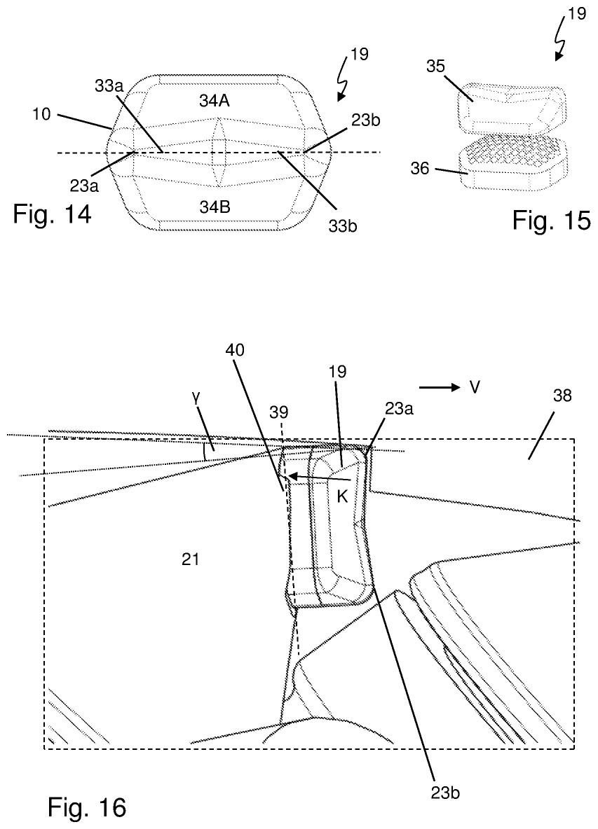

FIGS. 12, 13 and 14 further illustrate the specific geometrical design of the chisel tip bodies 19. FIG. 12 is a longitudinal view, FIG. 13 is a transverse view orthogonal thereto, and FIG. 14 is the top view showing the chisel tip body 19 from above orthogonally to the former two views. The chisel tip body 19 has a length L (FIG. 12), a width B (FIG. 13) and a height H (FIG. 14). The length L is larger than the width B at least by a factor 1.4.

What is of particular importance here is that, in contrast to the first embodiment example, the chisel tip body 19 includes two tips, more specifically the two cutting tips 23a and 23b. The two cutting tips 23a and 23b are spaced from one another by the distance S1 via the saddle region 24. The saddle region 24 includes, with respect to its ridge line, a saddle point W1 located halfway along the distance S1. At this lowest point of the ridge line of the saddle region 24, the ridge line is recessed towards the attachment side 26 by the distance S2. The two cutting tips 23a and 23b are rounded and have a curvature radius R1 in the longitudinal view according to FIG. 12 and a curvature radius R2 in the transverse view according to FIG. 13. Respective ridge lines 33a and 33b, which are essentially linear, extend between the saddle point W1 and the cutting tips 23a and 23b. The ridge lines 33a and 33b intersect at the saddle point W1 and together form a continuous linear ridge line. In the present embodiment example, they confine an angle α of approx. 170° (FIG. 12).

Along the longitudinal sides, the chisel tip body 19 comprises two continuous and nearly planar cutting flanks 34A and 34B. These lie at an angle β of approx. 100° relative to one another.

FIGS. 12, 13 and 14 illustrate in particular that the chisel tip body 19 is not rotationally symmetrical but in the present case includes two mirror symmetry planes E1 (FIG. 12; the plane extending through the chisel tip body 19 transversely to the connection line between the cutting tips 23a and 23b) and E2 (FIG. 13; the plane extending through the chisel tip body 19 and including the two cutting tips 23a and 23b).

FIG. 15 illustrates an approach for obtaining the chisel tip body 19 in the manufacturing process. According to the manufacturing process, the chisel tip body 19, which was integral in the previous figures, is subdivided into a cutting piece 35 and a bottom piece 36. This subdivision may be due to the manufacturing process. The cutting piece 35 here may in particular consist in essential parts of an ultra high strength material, in particular a PCD or NPD material, and may be manufactured separately in a first fabrication process. Further, a bottom piece 36 is provided which does not contain any PCD or NPD material and consists, for example, of a hard metal such as in particular tungsten carbide. In the present embodiment example, the single-piece chisel tip body 19 is obtained by sintering the cutting piece 35 onto the bottom piece 36, wherein a nubbed external surface may be provided on the contact surface of the bottom piece 36 towards the cutting piece 36 to improve this sintering process. However, alternative manufacturing techniques may also applied within the scope of the invention to obtain the chisel tip body 19. At the bottom piece 36, the chisel tip body 19 has an essentially constant width B and length L, which respectively correspond to the maximum width B and the maximum length L of the cutting piece 35. The cutting piece 35, on the other hand, is designed so as to taper, in particular in its width B, away from the bottom piece 36 and up to the ridge line between the two cutting tips 23a and 23b and the saddle point. In contrast to this, the length of the chisel tip body 19 is essentially constant across the cutting piece 35 and the bottom piece 36 up to the roundings of the cutting tips 23a and 23b.

FIG. 16 shows a cutout view of a chisel tip body 19 engaging the ground when the chisel tip body 19 is mounted in a manner according to the invention, for example, on a milling drum, as shown in more detail inter alia in FIG. 18. The ground 38 is removed by the chisel tip body 19 through cutting. In this case, the chisel tip body 19 is ideally mounted on the milling drum such that it produces a clearance angle γ (angle between the ground processed by the chisel tip body 19 and its side facing the ground (ridge line of the longitudinal side towards the cutting tip 23a)) of more than 1° (in the present embodiment example approx. 10°), but preferably not more than 15°.

FIG. 16 further illustrates that the force deflection of the force exerted on the chisel tip body 19 by the underlying ground in the milling process (force arrow K in FIG. 16) is mainly effected via the essentially planar soldering surface 39 between the chisel tip body 19 and the holding cap 21, which in the present embodiment example extends at an angle of approx. 86° and thus essentially orthogonally to this force transmission direction. This counteracts breakage of the chisel tip body 19 particularly effectively since in this manner shear loads acting on the connection point between the chisel tip body 19 and the holding cap 21 are particularly low.

FIG. 16 further shows side walls 40 located opposite each other (only one side is visible in FIG. 16), which extend at an angle, in particular essentially orthogonally, to the soldering surface 39 and also overlap the chisel tip body at the side walls. These side walls 40 facilitate, on the one hand, the mounting of the chisel tip body to the holding cap 21 since the chisel tip body can then be positioned on the holding cap in only two defined positions (which in the case of the twin tip thus involves the same spatial alignment of the chisel tip body with the holding cap), and, on the other hand, they improve attachment of the chisel tip body to the holding cap due to solder entering also between the side walls 40 and the longitudinal side wall of the chisel tip body during the soldering process.

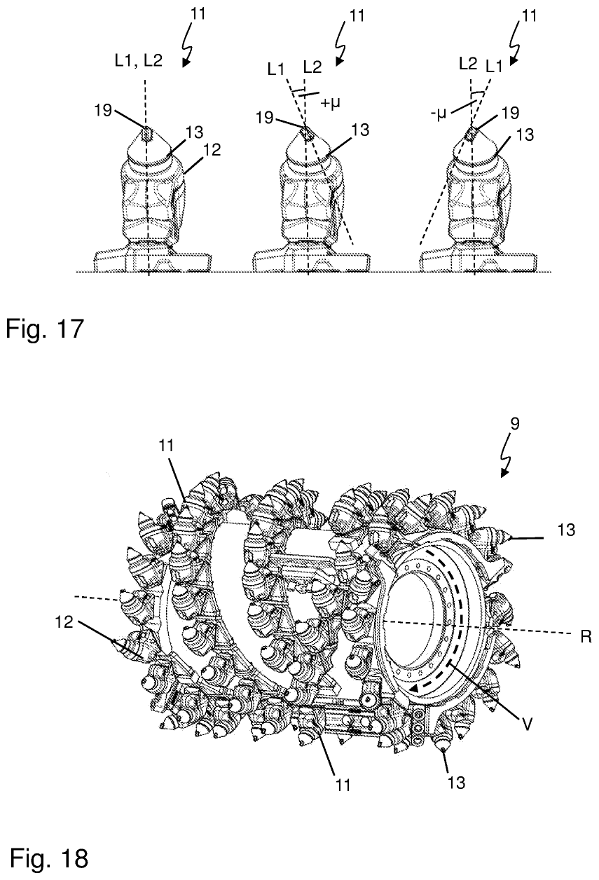

FIG. 17 shows three chisel devices 11 with inserted milling chisel 13 according to the second embodiment example in various rotational positions in a top view, i.e. essentially against the cutting direction. Line L1 represents the progression of the connection line between the two cutting tips 23a and 23b. Line L2, on the other hand, represents the orientation of the cutting tip 23a, which is positioned externally in the radial direction relative to the rotation axis of the milling drum, perpendicular to the rotation axis. The externally positioned cutting tip 23a provides the cutting circle of the milling chisel 13 in the underlying ground during working operation. In the view shown on the left-hand side, the lines L1 and L2 are congruent. In the view in the middle, the milling chisel 13 is twisted counter-clockwise by the angle μ, and in the view on the right-hand side, it is twisted clockwise by the angle μ. The alternative views of FIG. 17 now illustrate that even though the chisel tip body 19 is not arranged centrally with respect to the longitudinal axis P of the milling chisel, the cutting circle produced by the milling chisel 13 remains the same even for different rotational positions of the milling chisel. This also enables the creation of uniform milling patterns with the present milling chisel 13, and an exact positioning of the milling chisel is not required. Irrespective of this, devices may obviously be provided which serve for twist locking and/or specifying a particular position of the milling chisel 13.

An arrangement of a plurality of chisel tip bodies 19 on a milling drum is illustrated in FIG. 18. What is essential here is that, with the exception of chisels arranged at the end faces, the individual milling chisels 13 in the present embodiment example all have the same structure and are arranged in chisel holders 12 in a rotationally fixed manner

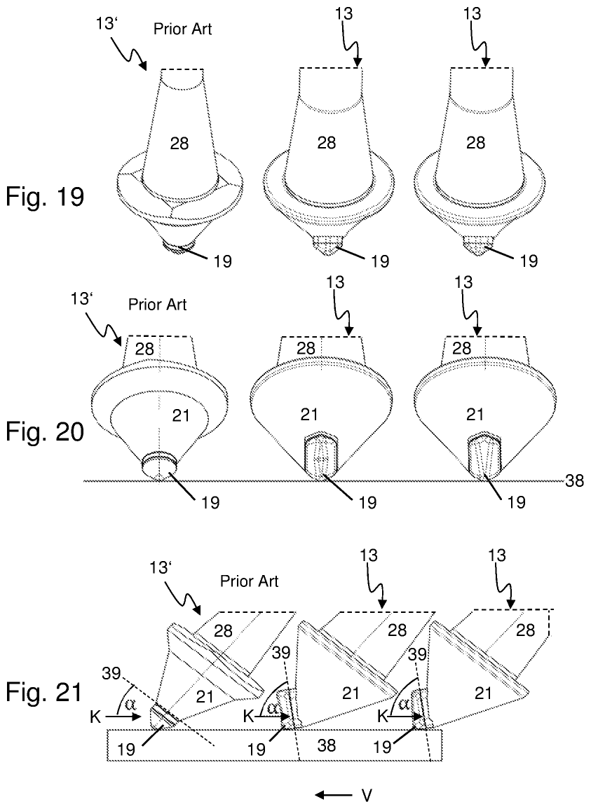

FIGS. 19, 20 and 21 illustrate a comparison of a conventional chisel 13′ (left-hand side), a milling chisel 13 according to the invention according to the second embodiment example (middle) and a milling chisel 13 according to the invention according to the first embodiment example (right-hand side) in a view in the approximate advancing direction V in milling operation (FIG. 19), against the approximate advancing direction V (FIG. 20) in milling operation and in a side view.

FIG. 19, to begin with, illustrates that, with respect to the tip region of the respective milling chisel, the two embodiments according to the invention (middle and right-hand side) as well as the prior art chisel form the actual tip of the milling chisel 13 through their respective chisel tip body. The cutting engagement thus occurs via the chisel tip of the chisel tip body in all cases. However, a significant advantage of the present assembly according to the invention is achieved through the specific elongate design of the chisel tip body and the mounting on the base body of the milling chisel in a laterally declining manner The chisel tip body and its attachment surface on the holding cap thus extend along the holding cap away from the tip of the milling chisel at the level of the holding cap in the direction of the longitudinal axis of the milling chisel. In the prior art according to the left picture, the chisel tip body is set atop the remaining milling chisel 13′, for example a holding cap, and does not extend along the holding cap of the milling chisel. In the milling process, the force is thus transmitted (force arrow K) to its attachment surface 39 in an acute angle α, whereas in the design according to the invention the force is transmitted at least in an obtuse angle α (preferably more than 70° and in particular more than 80° and thus nearly orthogonally. As a result, shear forces at the connection point of the chisel tip body 19 towards the holding cap 21, which might cause the chisel tip body 19 to be torn off, are reduced drastically and the milling chisel thus overall has a considerably higher loadability.

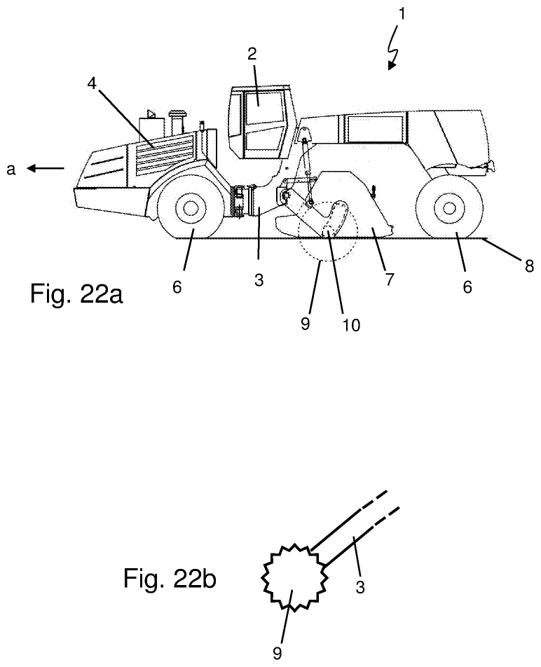

FIGS. 22a and 22b finally show specific examples of further ground milling machines which gain particular advantage from being equipped with milling chisels according to the invention. FIG. 22 shows a stabilizer/recycler in a design known per se. FIG. 22b shows a highly schematic view of a milling device as used, for example, in a trench miller or as an attachable unit. A surface miner may, for example, have the structure of the machine shown in FIG. 1.

What is claimed is:

1-17. (canceled)

18. A highly wear-resistant chisel tip body comprising:
a material comprising diamond particles or monocrystalline diamond structures, in particular a polycrystalline diamond (PCD), chemical vapor deposition (CVD) or nano-polycrystalline diamond (NPD) material, with a cutting top and a mounting bottom opposite the cutting top, via which the chisel tip body is attachable to a support body,
wherein the cutting top includes a cutting tip and two cutting flanks declining from the cutting tip and arranged opposite one another;
wherein, in a projection into a plane, the cutting top includes a circumferential outer contour and the cutting tip is arranged, with respect to the outer contour, at an off-center position within the outer contour; and
wherein, starting from the chisel tip, a ridge line is provided which extends towards a center of the outer contour and towards the opposite side and along at least one cutting flank and declines towards the mounting bottom such that the chisel tip, the ridge line and the two cutting flanks form a cutting wedge.

19. The chisel tip body according to claim 18, wherein the material has a hardness of more than 40 GPa and a bending rupture strength of more than 2 GPa.

20. The chisel tip body according to claim 18, wherein the chisel tip body is producable by sintering a tip body of a polycrystalline diamond matrix with a base body consisting of a hard metal.

21. The chisel tip body according to claim 18, wherein the ridge line is part of an essentially planar ridge surface.

22. The chisel tip body according to claim 18, comprising at least one of the following features:
a subregion shaped as an oblique pyramid;
the chisel tip body is surface-symmetrical and not rotation-axially symmetrical;
the outer contour is axially symmetrical and not rotationally symmetrical;
the outer contour is centrosymmetrical and not rotationally symmetrical;
the outer contour corresponds to a planar shape with at least four or more corners;
the ridge line and further contour lines on the cutting top of the chisel tip are rounded; and
the chisel tip body includes two opposed cutting flank surfaces which extend at an angle ranging from 60° to 150°.

23. The chisel tip body according to claim 18, wherein the chisel tip body comprises two chisel tips spaced from one another by a saddle region, the saddle region being recessed from the two chisel tips towards the attachment side.

24. The chisel tip body according to claim 23, wherein the chisel tip body comprises at least one of the following features:
the chisel tip body is axially symmetrical with respect to a symmetry axis through a lowest point of the saddle region;
the chisel tip body is not rotationally symmetrical;
the chisel tip body includes a symmetry plane extending through both cutting tips;
the chisel tip body includes a symmetry plane extending transversely to a virtual connection line between the two cutting tips; and
the saddle region comprises two ridge lines which extend within an angular range from <180° to 150° relative to one another.

25. The chisel tip body according to claim 18, wherein the chisel tip body has a length to width ratio larger than 1.2.

26. The chisel tip body according to claim 18, wherein the chisel tip body includes two opposed longitudinal edges extending within an angular range of +/−10°, and parallel to one another.

27. The chisel tip body according to claim 23, wherein the chisel tips and/or the transition in the saddle region are rounded with a rounding radius ranging from 1 mm to 3 mm.

28. The chisel tip body according to claim 18, wherein the chisel tip body is part of a milling chisel for a ground milling machine, the milling chisel having a chisel shank.

29. The chisel tip body according to claim 28, wherein the chisel tip body is arranged resting on an external surface of a circular cone such that a longitudinal axis of the chisel shank and a symmetry plane extending transversely to a virtual connection line between the two cutting tips intersect, in particular at an angle ranging from 30° to 60°.

30. The chisel tip body according to claim 18, wherein the chisel tip body is part of a milling chisel for a ground milling machine, the milling chisel having a support cap having an external surface to which the chisel tip body is attached by brazing.

31. The chisel tip body according to claim 18, wherein the chisel tip body is part of a milling drum for a ground milling machine.

32. The chisel tip body according to claim 31, wherein the chisel tip body has a clearance angle of >1°, up to a maximum of 20°.

33. The chisel tip body according to claim 31, wherein the chisel tip body is attached to a chisel tip support body of the milling drum, wherein an angle of a planar attachment surface via which the chisel tip body is attached to the chisel tip support body, to a tangential force transmission into the ground to be cut in working operation, is in the range from 70° to 110°.

34. The chisel tip body according to claim 18, wherein the chisel tip body is part of a ground milling machine.
